(19) United States
(12) Patent Application Publication
(10) Pub. No.: US 2008/0000997 A1
(43) Pub. Date: Jan. 3, 2008

(54) Safe-T-Shower

(76) Inventor: Duane Smith, Dresden, OH (US)

Correspondence Address: Raymond M. Galasso;Galasso & Associates LP, P.O. Box 26503, Austin, TX, 78755-0503, US

(21) Appl. No.: 11/713,486

(22) Filed: Mar. 2, 2007

Related U.S. Application Data
(60) Provisional application No. 60/779,183, filed on Mar. 3, 2006.

(51) Int. Cl. G05D 23/13

(52) U.S. Cl. 236/12.1; 29/729

(57) ABSTRACT

Safe-T-Shower is a device that allows consumers to set a water temperature for several different individuals. The preferred embodiment of the invention utilizes a control panel (program board), thermostat, and control valve. To use the preferred embodiment of Safe-T-Shower, an individual would set his temperature preference and access code in the control panel. When that user desires to take a shower, he would access his temperature preference from the control panel by entering his pre-set access code. In the preferred embodiment, each user would have an access code that could be typed into the control panel to begin the flow of water through the faucet by opening the hot and cold water lines. The thermostat behind the faucet would then measure the temperature of the water flowing through it and signal the control panel when the user's preferred temperature is reached. The control panel would then trigger the control valve to switch the flow of water from the faucet to the showerhead when the user's ideal shower temperature was reached. During the shower, if the temperature exceeds or drops below the user's preset specifications, the thermostat notifies the control panel which can in turn adjust the temperature mix of the water.

### CROSS REFERENCE TO RELATED APPLICATIONS

This United States Non-Provisional Patent Application claims priority to U.S. Provisional Patent Application No. 60/779,183 entitled “Safe-T-Shower” filed on Mar. 3, 2006.

### FIELD OF THE DISCLOSURE

The disclosures made herein relate generally to the shower accessories industry. The invention discussed herein is in the general classification of control panels, valves and thermostats for regulating water temperature.

### BACKGROUND

Most people undergo a morning ritual in preparation for going to work or school. Brushing teeth, putting on make-up, applying deodorant, taking medicine, and combing hair are but a few of the tasks most people undertake prior to leaving their home. Many individuals also take a morning shower.

Most individuals have a preferred water temperature for their showers. It is often difficult and inconvenient for each person showering to set the shower to his or her desired temperature each day. Some individuals also accidentally enter showers when the water temperature is too extreme, potentially causing a cold chill or, worse still, a burn from scalding water.

Hence, there is a need in the art for a convenient to use, affordable, durable, safe, effective thermostat, valve and control panel for regulating water temperature in a shower to an individual user's specifications.

A water heater in the home is used to heat the shower water and a brief description of how it operates is appropriate for an understanding of the present invention.

A water heater heats water on a continual basis, whether or not hot water is being consumed. When hot water is consumed, cold water enters the tank to replace the hot water drawn out. When the thermostat senses the water temperature has dropped below the hold level, it initiates the heating element(s) in an electric water heater or the burner in a gas model. Even when hot water is not being consumed, the temperature in the tank will fall and the water will be reheated to bring it back up to the desired temperature.

The cold water supply line connects to the water heater, typically on top of the appliance. Instead of dumping the water on top of the hot water in the tank, a dip tube carries the cold water down to the bottom of the tank. The outbound hot water line takes the water off the top of the tank. That way, when hot water is drawn out, it is at full temperature. Only after most of the hot water has been used do you start to get the hot and cold water mix.

When you open a hot water tap, the water pressure from the cold water supply line pushes the water out of the water heater and refills the tank with cold water. As cold water enters the tank, the thermostat(s) senses the lower temperature and triggers the heating mechanism.

Water heaters have a temperature and pressure relief valve to allow water to escape if the water pressure or temperature exceeds the limits of the tank. Tanks normally operate up to 150 psi. A valve is designed to release water from the tank when the pressure exceeds 150 psi. The valve will also open if the water temperature reaches 210 degrees (F.) or some other extreme temperature point. The valve typically has pipes connected to safely carry away the water without flooding or exposing people or pets to scalding hot water.

In the center of the water heater is an anode, sometimes called a sacrificial anode. The purpose of this piece of metal is to corrode instead of the tank corroding. The corrosive action of the hot water attacks the anode, extending the life of the tank. Furthermore, the tank has a bonded layer of glass to further protect it from corrosion.

The thermostat on a gas heater is an integral part of the gas control valve and is immersed inside the tank. When the temperature drops, the thermostat signals the gas control valve to supply gas to the burner. However, before it allows gas to flow, the thermocouple must signal that the pilot light is lit, otherwise a dangerous gas leak would occur.

The thermocouple is situated in or near the pilot flame. The heat of the flame creates millivolt current which engages a magnet in the gas valve. The gas valve releases gas in a burner adjacent to the pilot flame and is ignited. If the pilot goes out, the current stops and the magnet disengages, preventing the gas valve from opening.

Gas water heaters must be vented to the outdoors. The combustion of natural gas results in toxic carbon monoxide. In the center of the tank is a flew to carry the gases away to the vent mounted on top of the tank. The vent is critical because it carries the carbon monoxide outside the home.

On an electric heater the thermostats are in contact with the tank, and operate mechanically. The thermostat is like a switch. The switch is on by default, but when the temperature of the tank rises to a certain point, it expands and pushes a small metal rod against a dimpled piece of metal. That movement breaks the contact in the thermostat and stops current from flowing to the heating elements. The upper thermostat also functions as a reset switch and is sometimes referred to as the ECO (Energy Cut Off). Pressing the ECO restores to power to the water heater.

### SUMMARY OF THE DISCLOSURE

Safe-T-Shower is a device that allows consumers to set a water temperature for several different individuals.

The preferred embodiment of the invention utilizes a control panel (program board), thermostat, and control valve. The control panel allows consumers to set water temperatures for each person with each individual assigned a numerical code in the preferred embodiment. Ideally, the control panel would be located in the bathroom with the shower or in some other convenient location in the house.

The principal object of this invention is to provide a device that allows shower users to select their predetermined ideal water temperature without having to adjust the shower knobs manually.

Another object of this invention is to provide an affordable device for controlling water temperature in a shower.

Another object of this invention is to provide a device that controls water temperature and provides each user with his or her ideal water temperature, preventing extreme temperatures that could be dangerous to a user.

Another object of this invention is to provide an aesthetically pleasing device to control water temperature in a shower.

Another object of this invention is to provide a device that is easily used to control the water temperature in a shower.

Yet another object of this invention is to provide a durable device to control the water temperature in a shower.

### BRIEF DESCRIPTION OF THE DRAWINGS

FIG. 1 depicts a perspective view of the preferred embodiment of the control panel of the present invention.

FIG. 2 depicts a perspective view of the preferred embodiment of the control panel, thermostat and control valve of the present invention attached to a showerhead and hot and cold water lines.

### DETAILED DESCRIPTION OF THE DRAWINGS

The preferred embodiment of Safe-T-Shower is comprised of at least some of the following: a control panel (program board), thermostat, and control valve.

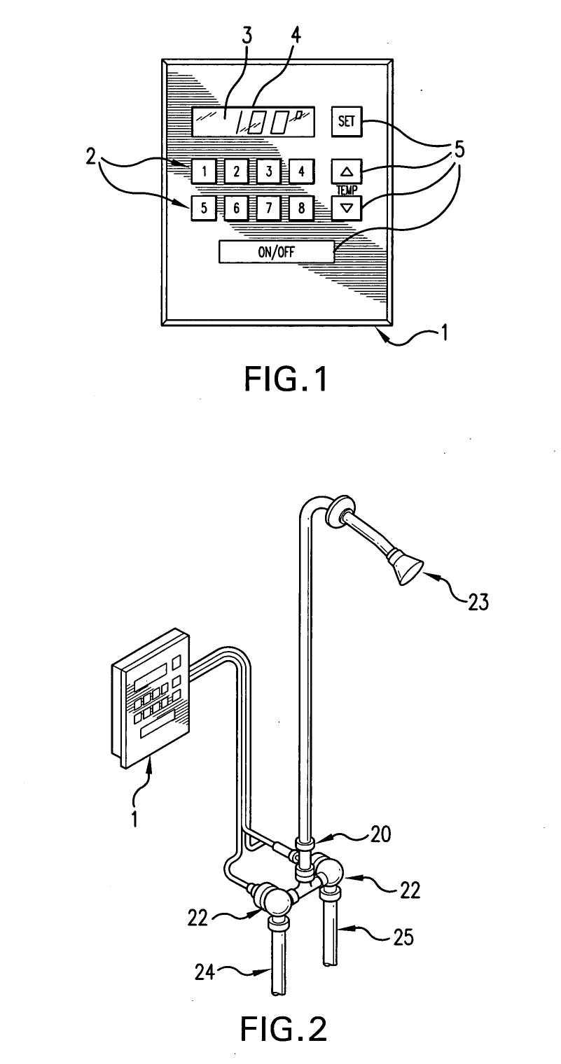

FIG. 1 depicts a perspective view of the preferred embodiment of the control panel of the present invention. The control panel 1 is approximately rectangular and made of plastic in this preferred embodiment to waterproof it from the water that may come into contact with it. The exact dimensions of the control panel 1 are not critical to the invention. The control panel 1 has a plurality of alphanumeric keys 2 for entering a code into the control panel 1. When the proper code is entered for a given user, the memory of the control panel 1 is accessed to determine the appropriate water temperature for a given user. In addition, the control panel 1 is operatively connected to the hot and cold water lines of the faucet through a control valve in this preferred embodiment to allow water to begin running at the appropriate temperature once a user enters his or her access code into the control panel 1. The control panel 1 also has a display screen 3 for providing various prompts related to setting and retrieving access codes. The display screen 3 has a transparent cover 4 made of plastic to protect it from water or other elements. The display screen 3 and the transparent cover 4 are rectangular in this preferred embodiment though the precise shape is again not critical. Control keys 5 that provide power to the control panel 1 and allow the user to set temperatures are also located on the control panel 1.

FIG. 2 depicts a perspective view of the preferred embodiment of the control panel, thermostat and control valve of the present invention attached to a showerhead and hot and cold water lines. A thermostat 20 is connected behind the faucet to measure the temperature of the water emanating from the faucet coming from the hot water line 24 and the cold water line 25. The thermostat 20 is also operatively connected to the control panel 1 to relay the current temperature of water emanating from the faucet to the control panel 1. Once the control panel 1 detects the appropriate water temperature from the thermostat 20, it relays a signal to a low voltage control valve 22 that switches the flow of water from the faucet to the showerhead 23.

The thermostat 20 of the preferred embodiment is approximately cylindrical in shape. While the exact shape and size of the device are not critical, it will ideally be small enough to be placed behind the faucet in a standard bathtub.

Safe-T-Shower can be used as a stand-alone device or could be integrated into a home security system. While the device is primarily discussed in conjunction with home use, it could also be used in commercial establishments such as hospitals, hotels and beauty salons.

Safe-T-Shower could also be used in showers with only showerheads and not faucets. In this alternative embodiment, the water would exit the showerhead once the control panel accesses a user's water temperature preference. The water would not initially exit the showerhead at the user's ideal temperature but would maintain that temperature once it was reached. The control valve would not need to switch the flow of water in this embodiment. Hence, “faucet” means either the traditional faucet located in a bathtub or the showerhead of the bathtub while “bathtub faucet” means only the faucet and not the showerhead of a traditional bathtub.

To use the preferred embodiment of Safe-T-Shower, an individual would set his temperature preference and access code in the control panel. When that user desires to take a shower, he would access his temperature preference from the control panel by entering his pre-set access code. In the preferred embodiment, each user would have an access code that could be typed into the control panel to begin the flow of water through the faucet by opening the hot and cold water lines. The thermostat behind the faucet would then measure the temperature of the water flowing through it and signal the control panel when the user's preferred temperature is reached. The control panel would then trigger the control valve to switch the flow of water from the faucet to the showerhead when the user's ideal shower temperature was reached. During the shower, if the temperature exceeds or drops below the user's preset specifications, the thermostat notifies the control panel which can in turn adjust the temperature mix of the water.

The materials utilized for Safe-T-Shower may vary widely but will likely include metals, plastic and electronic components. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Safe-T-Shower can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

All electronic components of the invention will also be ideally selected from those currently having the highest industry ratings. These components will also meet and/or exceed all safety and usage regulations. Wiring and associated connecting hardware should be insulated and otherwise protected from intrusion by any harmful or degrading elements, including water, medium level temperatures, and low to medium impact force.

It should be obvious that the components of the present invention can be of various shapes and sizes. It should also be obvious that the components of the invention can be made of different types of plastics or other suitable materials and can be of any color. Waterproof or water resistant materials would be best suited for application of the present invention.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A water temperature regulating device comprising:
(a) a control panel capable of being operatively connected to a hot water line and cold water line of a faucet; and
(b) a thermostat locatable behind the faucet and capable of being operatively connected to the control panel.

2. The device of claim 1 wherein the control panel is approximately rectangular.

3. The device of claim 1 wherein the control panel is made of plastic.

4. The device of claim 1 wherein the control panel has a plurality of alphanumeric keys.

5. The device of claim 1 wherein the control panel has a plurality of control keys.

6. The device of claim 1 wherein the control panel has a display screen.

7. The device of claim 6 wherein the display screen has a cover.

8. The device of claim 7 wherein the cover is transparent.

9. The device of claim 1 further comprising
a control valve capable of being operatively connected to the control panel and to the hot water line and the cold water line.

10. The device of claim 9 wherein the control valve is low voltage.

11. The device of claim 1 wherein the thermostat is cylindrical.

12. A method of installing a water temperature regulating device comprising the steps of:
(a) operatively connecting a control panel to a hot water line and a cold water line of a faucet through a control valve;
(b) attaching a thermostat to the control valve; and
(c) operatively connecting the thermostat to the control panel.

13. A water temperature regulating device comprising:
(a) a control panel capable of being operatively connected to a hot water line and a cold water line of a faucet through a control valve; and
(b) a thermostat capable of being connected to the control valve and operatively connected to the control panel.
